(19) United States
(12) Patent Application Publication
(10) Pub. No.: US 2018/0247473 A1
(43) Pub. Date: Aug. 30, 2018

(54) SYSTEMS AND METHODS FOR ON-DEMAND ACCESS TO REAL PROPERTY

(71) Applicants: Divyesh Panchal, St. Peters, MO (US); Adam Lorentzen, St. Louis, MO (US)

(72) Inventors: Divyesh Panchal, St. Peters, MO (US); Adam Lorentzen, St. Louis, MO (US)

(21) Appl. No.: 15/906,593

(22) Filed: Feb. 27, 2018

Related U.S. Application Data
(60) Provisional application No. 62/464,093, filed on Feb. 27, 2017.

(51) Int. Cl. G07C 9/00; G06Q 50/16

(52) U.S. Cl. CPC G07C 9/00103; G07C 2009/00769; G07C 9/00896; G06Q 50/16

(57) ABSTRACT

Systems and methods to allow a non-owner or similar party with no standard access to a property to temporarily access the property. The system utilizes a mobile device to perform a pre-certification of the party, allow them physical access to a property, resecure the property on their departure, and can initiate a transaction to obtain rights in the property based on the above.

### CROSS REFERENCE TO RELATED APPLICATION(S)

This application claims the benefit of U.S. Provisional Patent Application 62/464,093, filed Feb. 27, 2017, the entire disclosure of which is herein incorporated by reference.

### BACKGROUND

### 1. Field of the Invention

This disclosure relates to the field of identity verification systems and remote locks. In particular it relates to a system for allowing access to an individual interested in accessing the interior of a structure on a piece of real property, that is not an owner or renter of that property, by utilizing an electronic identity verification and access control system.

### 2. Description of the Related Art

The process of locating real property for purchase or lease can be extremely time consuming for the buyer. It has been estimated that 8% of buyers of residential property locate the specific property they purchase through signs and open houses and a majority (51%) locate the residence they purchase via the Internet. That means that around ⅔ of homes sold in the United States are identified by the buyer through their own searching.

At the same time, a buyer will only rarely purchase a piece of property without having at least walked through it once. For most buyers, seeing the property first hand is considered near essential, and while certain buyers are willing to make use of technology (including items such as virtual walkthroughs, live feeds, and other technology readily available on the Internet) to avoid a walk-through, they are relatively rare. In most cases, walkthroughs are only avoided for specific types of property and/or specific types of buyers. For example rehabbers or rebuilders that are only interested in location and price (since they often plan to tear structures down) often have no need to see the interior of structures on the property. Similarly, buyers where physical walkthroughs are logistically very complicated, for example for buyers that are at a great geographic distance from where they are purchasing, often are simply not able to do walkthroughs. The need to walkthrough property is often more psychological than strictly necessary given current technology, but the mental need to see and touch items before purchase is well known not just in the real estate industry, but in other big ticket industries as well such as automobile sales.

The problem with actually viewing real property is that it can also be massively time consuming and inconvenient for the buyer, the seller/leaser, and any agents involved in the property. Buyers will often want to tour properties when they have readily available time (which is often on weekends, mornings, or evenings) since this is when they can readily travel to the properties. However, this is often the worst time for sellers/leasers to make the property available because they may not have employees on site at these times.

To try and deal with this problem, the vast majority of on-the-market properties make use of a lock box. The lock box, which will commonly hang on the door knob, utilizes a combination lock to access a physical key to the property which is located therein. When a person wishes to view the property, they do so simply by contacting the seller/leaser and obtaining the combination to the lock box. They can then go to the property on their own schedule, obtain the key, and view the property at their leisure. When they are done, they return the key to the lock box after securing the property.

While lock boxes can deal with the problem of allowing access at any time, they create a whole host of new problems. The first is that they are necessarily insecure and create a risk of damage or theft to the property. Unless someone regularly changes the combination on the box, checks that the potential buyer actually locked the doors correctly when they left, and otherwise follows up after each tour, there may be a number of individuals that can access the property at any time without detection. In effect, lock boxes allow for the buyer to view the property on their own time, but the lock box does not avoid the need for the owner to also attend to the property on their time.

The second major problem with lock boxes is that the buyers will generally still need to be known to the seller before the seller will be willing to give them the lock box information. Specifically, the major security protection that the property owner has is in knowing who is looking at the property before they give them the lock box code. Thus, should something happen to the property by the action or inaction of a buyer, so long as the owner can narrow down the time window in which the issue occurred, they can usually narrow down who may have caused it. However, getting identity information to the seller presents new problems.

In the first instance, for the buyer, it may be more difficult to get to the owner (who may be in a remote location) than it is to get to the property meaning that the problem of the seller not being able to control their schedule still exists. Further, many sellers are reluctant to provide identification information to owners, particularly those that are not with large well-known companies, because of fear that their information could be stolen or improperly secured. The buyer is also forced to give the same information multiple times should they deal with multiple owners and cannot take a “spur-of-the-moment” tour when they simply happen to be near a property that now interests them.

For real estate sales, some of these issues are mitigated by the use of licensed real estate agents. Basically, the agents can act as an intermediary for both parties and the agents have a strong financial incentive to assist in the various scheduling issues. However, this is imperfect as it does not reduce the human time and overhead in the process (it actually increases it), it simply compensates the actors. Further, when it comes to leased property where turnover is commonly faster and the value associated with any new buyer is smaller, the property owner and/or buyer may not want to have to pay the cost of an agent for the transaction. Further, owners in leased situations commonly own multiple properties, and there is also often less negotiation over price and contract specifics than there is in a real estate sale. One of the principal benefits of a real estate agent is that they can assist with many aspects of the sale process, not just the tour, but these elements are often unnecessary in lease transactions.

From the above it should be clear that real estate showings of rental property have always required human intervention to pre-qualify candidates, physical presence of a representative of the leasing agent at the property around when the candidate wishes to tour, and management of multiple calendars to coordinate schedules. Current methods of real estate apartment or home showings are, therefore, inefficient for both landlords as well as prospective renters and buyers. Having to manage multiple calendars and coordination efforts often leads to missed showing and frustration for both parties.

The typical scenario for providing access involves renters or buyers having to initially take the active step of reaching out to specific property owners and leasing agents and providing their background information such as their income, rental history etc. in a verbal fashion over the phone. They may need to support the statements with scanned or faxed copies of documents, either prior to or at the showing. The owner then schedules a time for a showing and both parties need to be at the property at the proposed time.

From the above, it is clear that there is a need to provide a technological solution to a human problem of scheduling and identification. In particular, it would be desirable to have a system and method whereby a user can definitively identify themselves to a potential owner of property, without having to send the same documentation to multiple parties, and can be provided with a method for viewing property on their own and on their own schedule that does not require active maintenance by the landlord. The property owner would be interested in having a system whereby they can mitigate the security issues associated with lock boxes while still avoiding the need to have active staff on site at the property.

There are several forms of electronic locks available on the market which have been used in some instances to try and make tours simpler. However, they all require proprietary or specific infrastructure to be operated over the Internet (e.g. power, Wi-Fi etc.) which is often not present in a vacant property as empty apartments or homes commonly lack such infrastructure since a property owner will rely on new tenants to sign up for and install what they want with regards to such infrastructure. Because of this, many electronic locking systems are little more than an electronic lock version of the mechanical lock lockbox.

### SUMMARY

Because of these and other problems in the art, described herein is a system and method which utilizes a potential buyer's associated mobile device to both identify the buyer and to allow them access to a property.

In an embodiment there is described herein a system for allowing a non-owner of property the ability to enter a property, the system comprising: a locking mechanism for securing an access point to the property; a host computer; a mobile device under control of said non-owner; a lock controller for disengaging said locking mechanism; and a network access point for allowing said host computer to communicate with said lock controller; wherein said mobile device is registered on said host computer; wherein, when said mobile device is within a predetermined proximity of said lock controller, said mobile device can request an unlocking code from said host computer; wherein, said locking code can be transmitted from said mobile device to said lock controller to disengage said locking mechanism.

In an embodiment of the system, the lock controller can obtain acceptable codes to unlock said lock controller from said host computer via said network access point.

In an embodiment of the system, the lock controller and said network access point include power sources and do not utilize power from said property.

In an embodiment of the system, the locking mechanism is in a handle of a door and said locking mechanism can only disengage once for each said unlocking code.

In an embodiment of the system, a location of said mobile device is monitored while within said property.

In an embodiment of the system, after a predetermined period of time within said property, said mobile device is contacted by said host computer.

In an embodiment of the system, the when said mobile device is no longer within said property, said locking mechanism is reengaged.

There is also described herein, a method for allowing a non-owner of property the ability to enter a property, the system comprising: providing a locking mechanism for securing an access point to the property; registering a mobile device carried by said non-owner on a host computer; when said mobile device is within a predetermined proximity of said lock controller, said mobile device requesting an unlocking code from said host computer; said mobile device transmitting said locking code to said lock controller to disengage said locking mechanism; tracking said mobile device while it is within said property; reengaging said locking mechanism when said mobile device is no longer within said property.

In an embodiment of the method, the lock controller can obtain acceptable codes to unlock said lock controller from said host computer via said network access point.

In an embodiment of the method, the lock controller and said network access point include power sources and do not utilize power from said property.

In an embodiment of the method, the locking mechanism is in a handle of a door and said locking mechanism can only disengage once for each said unlocking code.

In an embodiment of the method, after a predetermined period of time within said property, said mobile device is contacted by said host computer.

### BRIEF DESCRIPTION OF THE FIGURES

FIG. 1 shows a flowchart of an embodiment of user verification.

FIG. 2 shows a block diagram of the major elements of an embodiment of a system for on-demand access.

### DESCRIPTION OF PREFERRED EMBODIMENT(S)

It will be readily understood that the components of the present invention, as generally described and illustrated in the figures herein, could be arranged and designed in a wide variety of different configurations, thus, the following more detailed description of the embodiments of a system as represented in the FIGS. are not intended to limit the scope of the invention, as claimed, but are merely representative of a presently preferred embodiment.

It should be recognized herein that this disclosure will generally refer to a rental or lease transaction but is also equally applicable to a purchase transaction. For simplification of terminology, this disclosure will presume that there are two parties to the transaction referred to as the “buyer” and “owner”. However it should be recognized that there may be many more parties involved due to the presence, or use, of intermediaries by one or both parties, or of more complex ownership arrangements. However, these additional parties will generally be associated with either the buyer or the owner, and can be segregated into the same categories.

It would also be well understood to one of ordinary skill in the art, that the “owner” of a property, as used herein, is not necessary the party owning the property (for example, the property may be technically owned by the bank as part of a security arrangement even while the person leasing or selling it has authority to act as if it was their own) and a “buyer” is not necessarily buying full title to a property but may be, for example, buying a partial title or specific form of title (e.g. as would be the case in a condominium sale or in purchasing a quitclaim deed), may be leasing the property for any length of time (e.g. a rental arrangement) and may have rights typically associated with an owner during that time (e.g. to make modifications to the property), or may be obtaining some right of use or ownership to the property for themselves or someone else including a fictitious entity.

Still further, the property in the present disclosure will generally be contemplated to be a residential property and specifically a property in a multi-family dwelling (e.g. an apartment). This is done for exemplary purposes only and the systems and method contemplated herein can be used in conjunction with the purchase or rental of any type of real property, and specifically any structure associated with real property, which has an interior which is generally maintained to have limited access by the public. Thus, it can include virtually any kind of commercial or residential real property. The property herein will also generally be considered to be vacant (that is, it has no tenant expected to be in the property at any time it would be toured). However, it should be recognized that the system can be used on occupied property in an alternative embodiment simply by adding a step of verifying that the occupier is not home at the time the tour is desired, and that the occupier is willing to allow a tour being given at that time.

Finally, while the present disclosure contemplates using the systems and methods for the sale or lease of real property, one of ordinary skill would also understand that the systems and methods can also be used for the sale or lease of other generally expensive and physically large objects which traditionally have access control and which have interiors not accessible to the general public (for example, automobiles).

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

For purposes of this disclosure, there will also be significant discussion of a special type of computer referred to as a “mobile communication device” or simply “mobile device”. A mobile device may be, but is not limited to, a smart phone, tablet PC, e-reader, satellite navigation system (“SatNav”), fitness device (e.g. a Fitbit™ or Jawbone™) or any other type of mobile computer whether of general or specific purpose functionality. Generally speaking, a mobile device is network-enabled and communicating with a server system providing services over a telecommunication or other infrastructure network. A mobile device is essentially a mobile computer, but one which is commonly not associated with any particular location, is also commonly carried on a user's person, and usually is in near-constant real-time communication with a network allowing access to the Internet.

As will be appreciated by one skilled in the art, some aspects of the present disclosure may be embodied as a system, method or process, or computer program product. Accordingly, these aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory. The term “app” may be used to generally refer to a particular software element, of any kind, which is designed specifically to run on a mobile communication device.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the terms “web,” “web site,” “web server,” “web client.” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “real-time” refers to software operating within operational deadlines for a given event to commence or complete, or for a given module, software, or system to respond, and generally invokes that the response or performance time is, in ordinary user perception and considered the technological context, effectively generally cotemporaneous with a reference event. Those of ordinary skill in the art understand that “real-time” does not literally mean the system processes input and/or responds instantaneously, but rather that the system processes and/or responds rapidly enough that the processing or response time is within the general human perception of the passage of time in the operational context of the program. Those of ordinary skill in the art understand that, where the operational context is a graphical user interface, “real-time” normally implies a response time of no more than one second of actual time, with milliseconds or microseconds being preferable. However, those of ordinary skill in the art also understand that, under other operational contexts, a system operating in “real-time” may exhibit delays longer than one second, particularly where network operations are involved.

The system contemplated herein generally comprises three major elements which provide for different pieces of an overall property transaction related to allowing for simplified showing and transfer of rights in property. The first element is a buyer pre-certification which is preferably performed with a third party coordinator to allow for a buyer to only have to carry out the process once. The second element is directed to allowing the buyer physical access to the property without any additional human intervention and in accordance with the buyer's schedule. The third element allows for a buyer to initiate a transaction to obtain rights in the property based upon their interest from the second element should they wish to do so and potentially complete a rights transfer shortly after the tour. Again, the third element may occur without human intervention on behalf of the owner in some scenarios.

The first element generally provides that the buyer be certified as acceptable to view the property. As would be appreciated by one of ordinary skill in the art, the necessary requirements to certify any buyer as “acceptable” may be specific to an owner or may be selected to be generally acceptable to a wide variety of owners. In an embodiment, the buyer will certify themselves to a third party lease coordinator (referred to as a “coordinator” herein) which will generally be the party that operates the systems and methods discussed herein specifically controlling the host computer (203).

The coordinator will generally provide for remote certification of a buyer using any methods and systems available in the art that are of value to them. For example, the coordinator may require the buyer to fill out an online form on the web with various informational elements about themselves. To the extent that these elements can be verified through other parties (e.g. public records or by running a credit report) the coordinator may perform such verification as they desire. The coordinator may also require the buyer to submit certain forms of proof of identity or of other aspects of themselves. This could be something like a copy of a driver's license to verify their current address or a pay stub to verify their employment. These supporting documents may be required during the initial transmission and account setup, as a later follow up to get access to additional features, or to allow the buyer to utilize the lease negotiation element discussed later.

Regardless of the specifics of the verification step related to the buyer's suitability as a buyer to any owner, the coordinator will generally require the buyer to associate a particular mobile device with their account as part of the verification. This connection of a mobile device to the account allows for the buyer to use the second element (the on-demand tour of property) of the systems and methods. Commonly the mobile device will be a smartphone or other similar device the buyer will generally maintain on their person and which has the ability to access the Internet using generally available networks (e.g. cellular networks) instead of requiring infrastructure that would typically only be available in an occupied structure (e.g. Wi-Fi). It is recognized that as the technology of networks advances, different kinds of networks are becoming increasingly available in an increasing number of places and, thus, the present disclosure specifically contemplates that the coordinator would choose the device based on its ability to use a communication protocol appropriate for the technology of the time.

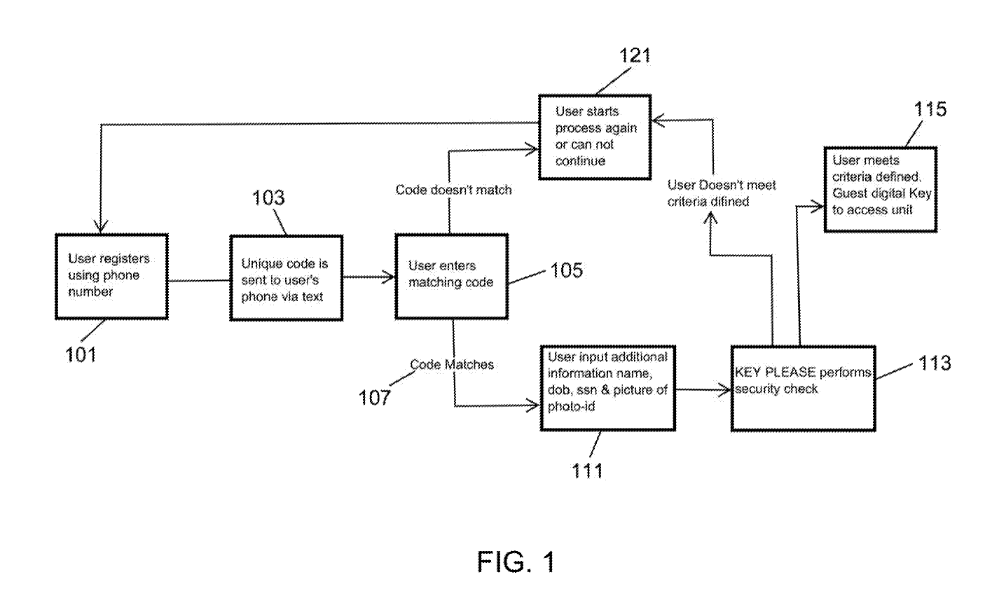

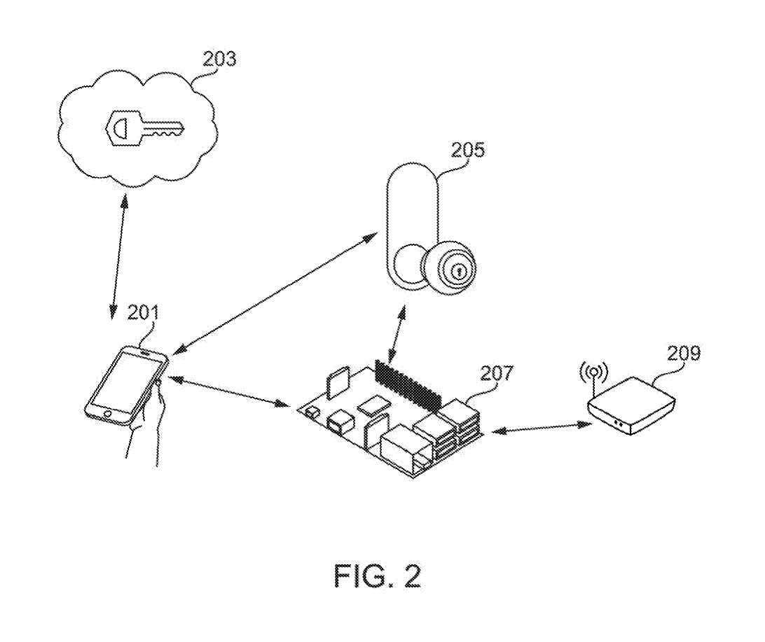

The coordinator will generally require verification of the device by the buyer to show that it is truly associated with them and then will generally register the device as associated with a particular memory record (account) at the host computer (203) corresponding to this buyer. FIG. 1 provides an embodiment of such a verification procedure. As can be seen with reference to FIGS. 1 and 2, the buyer will provide a network locator (such as a phone number or IP address) of the mobile device (201) they wish to associate (101) to the host computer (203) of the coordinator. Upon receipt of this locator at the coordinator's systems, the coordinator's system will communicate with the mobile device (201), such as by texting, and send a unique ID code (103). The user of the mobile device (201) will then enter this code (105) in their registration application to identify that they got the code and associate the mobile device (201) with the account they have set up at the host computer (203).

If the user enters the correct code (107), additional information may be requested from the user (111) to create the account, or the previously entered information from the user may now be associated with this account. The information entered is then used to perform any form of desired verification (113). This can include, but is not limited to, review of Division of Motor Vehicles (DMV) records, a credit check using a credit agency, a criminal background check, or any other verification known now or later discovered. It is preferred that at least some of the verification be performed in real-time or near real-time so that a buyer may register with the system immediately prior to viewing a property even if they have not registered previously.

If a buyer passes both the mobile device verification (107) and the identify verification (113), the buyer is now authorized to view properties using the system (115). If the buyer fails either step, they are generally denied (121) and may be given the option to attempt the registration process again. If a user repeatedly fails, they may be blocked from the system as a way to inhibit use of the system for illegal or unauthorized purposes. Depending on the level of security desired, in some embodiments the buyer need not provide any information other than the identification of the associated mobile device to become a verified account.

Once the buyer is recorded in the coordinator's records, the buyer is eligible to view properties. The buyer will then generally locate properties they wish to view using any technique of interest to them. For sake of simplicity of discussion, the example provided here is that the buyer is simply traveling on a public thoroughfare and sees a sign indicating a vacant property that they wish to view. It should be recognized that, as discussed above, it is preferred that the verification process occur quickly so that the buyer can actually become authorized in a reasonable time window while they are standing at the sign for the desired property. This allows the buyer to learn about the coordinator's system via traditional signage and other real estate listing methodologies and it allows them to view a property they have just found without any unreasonable delay or having to travel to any location separated from the property of interest.

Referring primarily to FIG. 2, when an authorized buyer has located a property they wish to tour, they will utilize their mobile device (201) to request access. The mobile device (201) may include a software app residing in its memory for this purpose, or the mobile device (201) may access a host computer using an Internet browser or other software accessing the web that allows more general access to content over a network. Regardless of connection methodology, the mobile device (201) will contact the host computer (203). The host computer (203) will receive identification information from the mobile device (201) (either automatically or user entered) which will allow the host computer (203) to retrieve the account of the buyer. The buyer may then be verified as the buyer associated with this account using any verification methods known to one of ordinary skill in the art (e.g. the buyer may need to enter a password) and will obtain information (either automatically or user entered) on the property the buyer wishes to tour. Upon verification, the host computer (203) will send a digital key (essentially security credential software) to the mobile device (201).

While any kind of verification may be used before the digital key is provided, one particularly useful verification is the current geographic location of the mobile device (201). As the buyer is requesting access to a particular property, the host computer (203) may only send a security key if the mobile device (201) is within a certain distance of the property to which the access is being requested. This inhibits an individual from requesting large numbers of keys to potentially use for illicit purposes and to make sure that they get the correct key to the property they wish to view based on their physical proximity to it.

Once the mobile device (201) has been provided the digital key, the buyer simply brings the mobile device (201) into close proximity to the door of the structure. At this time a lock controller (207) will exchange security credentials with the mobile device (201). This exchange may utilize any communication protocol known now or later discovered, including, but not limited to, Bluetooth™, BLE (Bluetooth™ Low Energy), or Z-Wave™. If the digital key on the mobile device (201) is verified as authorized by the lock controller (207), the lock controller (207) disengages the lock (205) allowing the buyer to access the property. The key will generally be intended for single use so that storing it does not allow the buyer to enter the property at any later time.

The lock (205) may be any kind of lock capable of receiving information from a mobile device (201) depending on embodiment. However, it is often preferred that the lock (205) comprise a lock with the locking mechanism located on the handle as opposed to a deadbolt lock. A concern with a deadbolt lock mechanism is that it typically will require the buyer to throw the lock, from external the property, after they leave. As the buyer does not have a key, this will typically be by having their mobile device (201) send a signal to the lock (205) to reengage. While this is preferably done automatically (e.g. when the buyer moves a certain distance from the property) to make sure it is accomplished, it can be difficult to verify that the lock (205) has actually been correctly engaged in a deadbolt style lock in sufficient time to correct for a problem.

In a preferred embodiment, the locking mechanism for the lock (205) is located on the handle. This may be done in conjunction with a deadbolt lock or alone. In this embodiment, the code to unlock the lock (205) may allow for unlocking to only occur once with that particular code and only on the handle, which is otherwise always locked. This allows the buyer to open the door and go inside. However, as soon as the door closes, the lock will generally reengage from the outside (even though the door can be opened from inside the property). In this way, the door is known to be secured so long as the buyer closes it when they leave. This can inhibit a buyer from inadvertently forgetting to engage the lock, or from the deadbolt not correctly engaging because while the buyer closed (or did not close) the door, the thrown bolt was not aligned with the receiver.

Another advantage of using a handle based lock (205) is that it can be used in conjunction with a deadbolt that cannot be controlled by the mobile device (201). In this case, for example, it is possible to allow for a service person to also use the system in addition to or instead of a buyer. For example, an apartment complex interested in renting apartments could utilize the system to both allow buyers to view the apartments prior to rental and to allow for service technicians to service the apartments after rental. In this type of arrangement, the deadbolt lock could be left open during proposed rental availability relying on the handle lock to secure the apartment. In the service situation, the professional may be provided with a handle code which will work at any time, but if the apartment renter is home, they can simply lock the deadbolt lock which will not allow the service professional to enter at that time.

While the buyer is on the property, the buyer may be monitored by security systems and the like to determine what they are doing. Their movement within the property may also be tracked by utilizing position location systems internal to their mobile device (201). In order to assure that the buyer is not utilizing the property for unintended purposes, and that they don't stay too long, the time since the door lock (205) disengaged is generally monitored. Should a preset time limit be passed and the user is believed to still be in the property, the host computer (203) and/or lock controller (207) may send a notification to the buyer indicating that they should be preparing to leave. This can be followed up by a variety of escalating messages if they do not, including the host computer (203) or lock controller (207) notifying the coordinator of the issue, or contacting law enforcement.

Once the buyer has completed their tour and is ready to leave they will generally indicate that they are done. This will be a cue that the property can be secured again. Specifically, the buyer may indicate that they are ready to leave by again exchanging the security credentials with the lock controller (207) to reengage the lock (205) or may simply leave pulling the door closed behind them to engage the lock (205). Alternatively, they may simply press a button or other indicator on their mobile device (201) which cues the lock controller (207) to reengage the lock (205). The lock controller (207) will generally be able to monitor the lock's (205) status, so should the lock (205) not be correctly engaged (e.g. if the door was left open when the lock (205) attempted to reengage or if the buyer moved too far from the property) the lock controller (207), and/or host computer (203) may notify the buyer and/or the controller to attempt to rectify the situation.

Once the tour is complete, the lock controller (207) will generally use internal software to disallow the security credential that was just used. Thus, for the buyer to go on another tour of the same property later, they will need to request a new digital key. The lock controller (207) may also update the host computer on any information that was obtained about the buyer by the lock controller (207) while the buyer was in the structure. The connectivity of the lock controller (207) to the host computer (203) is often through a network access point (209) which is specifically connected to the lock controller (207) for this purpose.

The embodiment of FIG. 2 utilizes a lock (205) and a lock controller (207) to deal with the fact that many electronic locking systems do not actually include Internet capable communication systems. This can be done as a security precaution, or simply for ease of use or cost. In the embodiment of FIG. 2, the lock controller (207) works in conjunction with a provided network access point (209) which is designed to allow the lock controller (207) to access the host computer (203) to obtain updates and additional information and can also allow it to access other resources, if necessary. The network access point (209) can be specifically designed to utilize a portable power source (e.g. a battery or solar panel) so that the network connectivity is provided without having to connect either the lock controller (207) or network access point (209) to power infrastructure in the structure as power is often off in a vacant structure.

The network access point (209), by providing access from the lock controller (207) to the host computer (203), allows for the digital keys that are acceptable to be provided remotely instead of having to be programmed in close proximity to the lock (205). This eliminates a need for a human to regularly go to the property to update the digital keys. In an embodiment, the lock controller (207) comprises an embedded cellular enabled microcontroller. This may be provided utilizing dedicated hardware, or through a programmed general purpose system such as a Raspberry Pi™ in software. Currently, many electronic locks rely on Wi-Fi as a gateway to control via internet and can't access the Internet directly which is why the lock controller (207) and network access point (209) may be included. In the future, modification of locks (205) to have a lock controller (207) may be unnecessary as they may internally include non-gateway systems for accessing the Internet, web, or another large network.

While the network access point (209) may no longer be needed after the property is occupied and will typically be removed, it should be apparent that there is no need to remove the lock (205) or lock controller (207) from the door of the property after the property is obtained by a buyer. The buyer may wish to do so due to security concerns, but because the access key control is held by a third party coordinator (and not the owner of the property) this may assuage some concerns and the buyer can be given some control over the lock controller (207).

Keeping the lock controller (207) with the property also allows for certain benefits to the buyer. For example, if the buyer has a maid or other service provider that comes to the property on a certain schedule, that service provider could be registered to have an account with the coordinator in much the same way as the buyer, and could be provided access to the property to provide the service at specific times in virtually the same manner as was originally provided to the buyer above. The service provider also could be monitored while they are within the property in the same manner as the buyer. This can provide increased security to the buyer as the service provider does not have unfettered access from having an extra key to the property, but is provided a new key each time they visit and the visits include some monitoring capability. Similar types of access can be provided to maintenance personnel of the owner or other parties that the buyer may want to have limited access to the property, such as a short-term subtenant.

After the tour has completed, the system may provide additional information to the buyer. In an embodiment, this can be basic survey information so the buyer can review what they thought of the property. In another embodiment, the system can actually provide the buyer with the ability to obtain the property. Effectively, the buyer can indicate after the tour is complete that they are interested in obtaining the property to the software app. If this is the case, the app can provide necessary documentation and indication of prices, available move-in dates and the like. So long as the paperwork is generally formulaic and acceptable to the buyer as is, or with minimal modification that an owner has preapproved (for example, the buyer may select a custom term of the lease, but it is automatically acceptable to the owner so long as it is within an allowed range), the entire transaction can effectively be completed within the app within a short time window after the tour is completed.

To be able to complete the transaction, it will generally be desirable that the buyer previously have provided sufficient verified information to the coordinator so that the owner of the property has already accepted that they meet all necessary purchase requirements. As the information is held and verified by the coordinator, the owner can be certain that if they specified requirements to the coordinator, the coordinator can verify that they are met before allowing the transaction to continue and the coordinator can collect information to meet the requirements of a variety of different owners. In an embodiment, if the buyer cannot meet the requirements, they may even be informed of that fact before being provided with access to the property so they can use that fact to evaluate if they wish to tour it at all.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A system for allowing a non-owner of property the ability to enter a property, the system comprising:
a locking mechanism for securing an access point to the property;
a host computer;
a mobile device under control of said non-owner;
a lock controller for disengaging said locking mechanism; and
a network access point for allowing said host computer to communicate with said lock controller;
wherein said mobile device is registered on said host computer;
wherein, when said mobile device is within a predetermined proximity of said lock controller, said mobile device can request an unlocking code from said host computer;
wherein, said locking code can be transmitted from said mobile device to said lock controller to disengage said locking mechanism.

2. The system of claim 1 wherein said lock controller can obtain acceptable codes to unlock said lock controller from said host computer via said network access point.

3. The system of claim 2 wherein said lock controller and said network access point include power sources and do not utilize power from said property.

4. The system of claim 1 wherein said locking mechanism is in a handle of a door and said locking mechanism can only disengage once for each said unlocking code.

5. The system of claim 1 wherein a location of said mobile device is monitored while within said property.

6. The system of claim 5 wherein after a predetermined period of time within said property, said mobile device is contacted by said host computer.

7. The system of claim 5 wherein when said mobile device is no longer within said property, said locking mechanism is reengaged.

8. A method for allowing a non-owner of property the ability to enter a property, the system comprising:
providing a locking mechanism for securing an access point to the property;
registering a mobile device carried by said non-owner on a host computer;
when said mobile device is within a predetermined proximity of said lock controller, said mobile device requesting an unlocking code from said host computer;
said mobile device transmitting said locking code to said lock controller to disengage said locking mechanism;
tracking said mobile device while it is within said property;
reengaging said locking mechanism when said mobile device is no longer within said property.

9. The method of claim 8 wherein said lock controller can obtain acceptable codes to unlock said lock controller from said host computer via said network access point.

10. The method of claim 8 wherein said lock controller and said network access point include power sources and do not utilize power from said property.

11. The method of claim 8 wherein said locking mechanism is in a handle of a door and said locking mechanism can only disengage once for each said unlocking code.

12. The method of claim 8 wherein after a predetermined period of time within said property, said mobile device is contacted by said host computer.
